(19) United States
(12) Patent Application Publication
(10) Pub. No.: US 2023/0249987 A1
(43) Pub. Date: Aug. 10, 2023

(54) SMALL SEWAGE TREATMENT PLANT

(71) Applicant: Bodo Richter, Bad Honnef (DE)

(72) Inventor: Bodo Richter, Bad Honnef (DE)

(21) Appl. No.: 18/013,058

(22) PCT Filed: Jul. 1, 2021
(86) PCT No.: PCT/EP2021/068141

§ 371 Date: Dec. 27, 2022

(30) Foreign Application Priority Data
Jul. 2, 2020 (DE) 20 2020 103 837.0

(51) Int. Cl. C02F 1/00

(52) U.S. Cl. CPC C02F 1/004; C02F 2103/005

(57) ABSTRACT

A small sewage treatment plant comprises a first sewage tank in which a preliminary clarification takes place due to the sinking of solid particles to the bottom of the first sewage tank, and a filtering device in a second sewage tank, which filtering device comprises several filters and to which the pre-clarified sewage is fed from above for further clarification. The filtering device has a rotary plate which is rotatable about a vertical axis of rotation and stores several filter containers, each filter container including several filters arranged above each other. In a lid of the second sewage tank, a closable tank opening is provided, via which at least one filter is removable when the associated filter container is opposite to the tank opening after a corresponding rotation of the rotary plate.

### CROSS REFERENCE TO RELATED APPLICATION

This application is a National Phase of International Application No. PCT/EP2021/068141, filed Jul. 1, 2021, which claims the benefit of German Application 20 2020 103 837.0, filed Jul. 2, 2020, both of which are incorporated herein in their entireties.

### TECHNICAL FIELD

The invention relates to a small sewage treatment plant comprising a first sewage tank with a sewage feed line, in which a preliminary clarification takes place due to the sinking of solid particles to the bottom of the first sewage tank, a second sewage tank which is connected to the first sewage tank via an overflow through which pre-clarified sewage can be fed to the second sewage tank, a filtering device in the second sewage tank, which filtering device comprises several filters and to which the pre-clarified sewage is fed from above for further clarification, and an outlet which is arranged below the filtering device and via which the filtered sewage is dischargeable.

### BACKGROUND

Such a small sewage treatment plant serves to clarify sewage with a rated value of four to five inhabitant units, in particular for the use in housing units for five to twenty people. Thus, they are used in detached houses, small settlements, restaurants/guesthouses or shelters, when a sewage disposal by way of a connection to large communal sewage treatment plants is out of question due to technical, statutory or financial reasons. Typically, the sewage clarification takes place by means of two sewage tanks, wherein the preliminary clarification takes place in a first sewage tank and the pre-clarified sewage is fed to the second sewage tank, where it is further clarified by a filter packet in the filtering device that is effective as a biological filter without forced ventilation. The clarified sewage is then discharged from the second sewage tank via a lower outlet. In operation, the first sewage tank is thus always filled with sewage up to the overflow, while no sewage collects in the second sewage tank that is emptied continuously.

The filters used in the small sewage treatment plant must be maintained and cleaned at regular intervals depending on the load. In this process, the settling sludge is extracted from the first sewage tank and disposed of. The cleaning of the filters in the filtering device is carried out inside the second sewage tank, typically by inserting a water hose through tank openings in the second sewage tank and spraying the filters with water to clean them. Since accessibility to the second sewage tank is limited, the cleaning process is difficult.

### SUMMARY

It is the object of the invention to specify a small sewage treatment plant, the maintenance and cleaning of which is improved.

This object is solved in that the filtering device comprises a rotary plate which is rotatable about a vertical axis of rotation and which stores several filter containers, each filter container comprising several filters arranged one above the other, and in that a closeable tank opening is provided in a lid of the second sewage tank, via which opening at least one filter can be removed when the associated filter container is opposite to the tank opening after a corresponding rotation of the rotary plate.

According to the invention, one or more filters of the respective filter container can be removed and cleaned outside the second sewage tank. It is advantageous when the entire filter container with its filters is removably mounted in the rotary plate and this filter container is removed via the tank opening in order to clean it together with its filters outside the second sewage tank. The maintenance of the filtering device in the second sewage tank and also its cleaning is facilitated in this way. In addition, filter containers that are non-functional can be easily replaced as a whole with functional ones.

According to one embodiment, a distribution device is provided above the filtering device, which distribution device is connected to the overflow and via which pre-clarified sewage can be supplied to at least one filter container. Typically, the distribution device distributes the pre-clarified sewage more or less equally to all filter containers present in the rotary plate. It is also possible to configure the distribution device such that it distributes pre-clarified sewage to selected filter containers only, for example, when a filter container is impaired in its function. It is also possible to throttle the supply of sewage to selected filter containers, thereby reducing the load on the affected filter containers. In this way, maintenance and cleaning intervals can be extended.

Another preferred embodiment provides that several filters of a filter container are combined into a filter group, this filter group being removable via the tank opening. In this case, maintenance and cleaning can be simplified in that more heavily loaded filter groups are cleaned more frequently than less heavily loaded filter groups.

### BRIEF DESCRIPTION OF THE DRAWINGS

In the drawings, an embodiment according to the prior art and an embodiment according to the invention are illustrated.

FIG. 1 schematically shows a small sewage treatment plant according to the prior art,

FIG. 2 shows a small sewage treatment plant according to an embodiment of the invention,

FIG. 3 shows a schematic top view of the second sewage tank,

FIG. 4 shows a side view of the second sewage tank,

FIG. 5 shows a perspective CAD illustration of the small sewage treatment plant,

FIG. 6 shows the small sewage treatment plant and the removal of a filter container, and

FIG. 7 schematically shows a ball roller for rotatably mounting the rotary plate.

### DETAILED DESCRIPTION

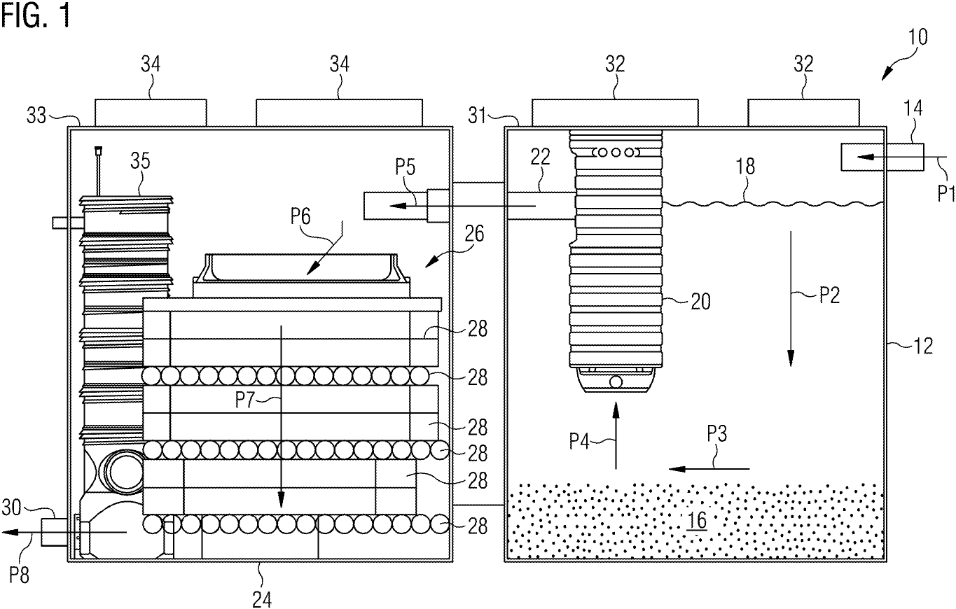

In FIG. 1, a small sewage treatment plant 10 according to the prior art is illustrated. It comprises a first sewage tank 12 to which sewage is supplied via an inlet 14 according to the arrow P1. In the first sewage tank 12, a preliminary clarification of the sewage takes place as a result of solid particles 16 sinking to the bottom; lighter particles, such as oils and fats, collect near the surface 18 of the sewage. The sewage passes according to the arrows P2, P3 and P4 to a prefilter 20 which comprises various filter layers for prefiltering. The pre-clarified sewage passes via an overflow 22 to a second sewage tank 24 and is supplied according to the arrows P5 and P6 to a filtering device 26 which comprises several filters 28, in which inter alia also a biological filtering takes place. The sewage to be clarified trickles through the filtering device 26 according to the arrow P7 and exits the small sewage treatment plant 10 below the filtering device 26 as a filtered sewage via an outlet 30 according to the arrow P8.

The lid 31 of the first sewage tank 12 contains two closeable openings 32. Via these openings 32, sludge and solid particles and superficial waste from the inside of the sewage tank 12 can be sucked off and disposed of. By means of water, which is sprayed under high pressure into the first sewage tank 12 and the prefilter 20, a cleaning takes place. In the second empty container 24, too, two closeable openings 34 are included in the lid area 33, through which an inspection of the dirt condition via a sight pipe 35 and/or a cleaning takes place. In this process, a water hose is inserted into the second sewage tank 24 via the opening 34 and the filtering device 26 and the interior space are flushed out and cleaned under high pressure. Since accessibility to the second sewage tank 24 is considerably limited, the cleaning process is relatively difficult and replacement of filters 28 is complicated.

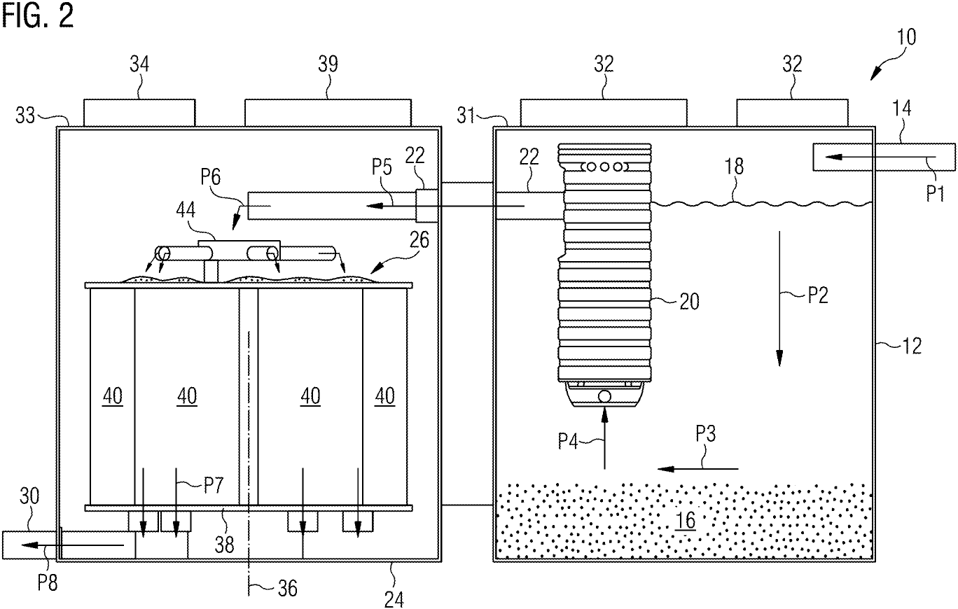

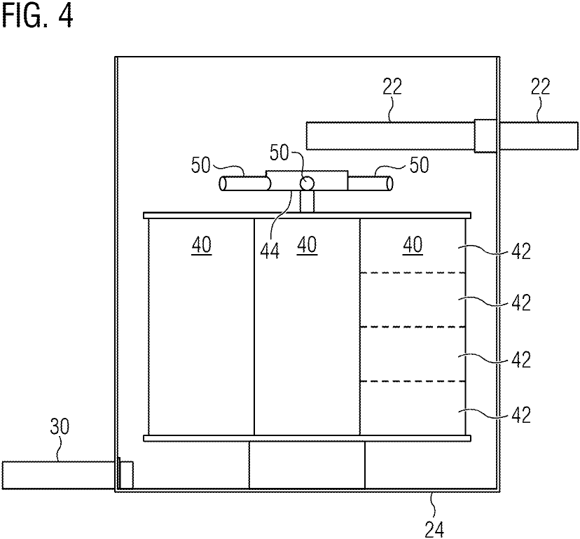

FIG. 2 shows the small sewage treatment plant 10 in an inventive design. The same elements are identified with the same reference signs in the following. Here, too, the pre-clarified sewage is fed via the overflow 22 in the direction of the arrow P6 to the filtering device 26 via a distribution device 44. This filtering device 26 comprises a rotary plate 38 which is rotatable about a vertical axis of rotation 36 and stores several filter containers 40. Each of these filter containers 40 comprises several filters 42 arranged on top of each other, as this is exemplarily illustrated in FIG. 4. Above the rotary plate 38, a distribution device 44 is arranged, which distributes the pre-filtered sewage to the various filter containers 40.

A closeable tank opening 39 is included in the lid 33, the opening width of which is greater than the diameter of the filter container 40 such that the filter container 40 or at least a filter 42 contained therein can be removed when a specific filter container 40 is opposite to the tank opening 39 and is aligned therewith by a corresponding rotation of the rotary plate 38.

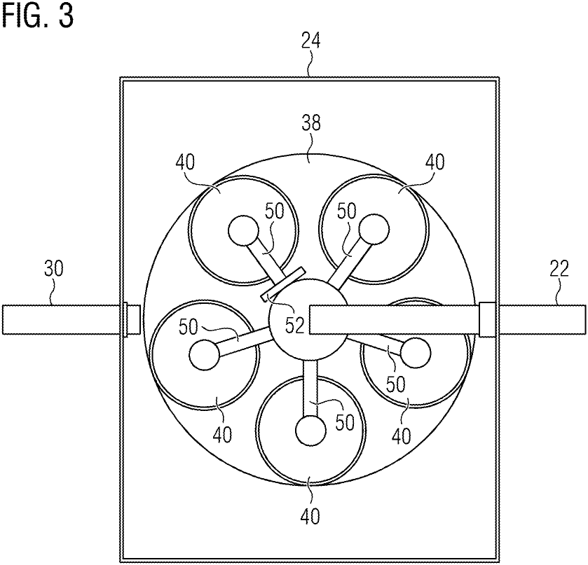

FIG. 3 shows a top view of the second sewage tank 24. What can be seen is the arrangement of the filter containers 40 on the base of the rotary plate 38. The distribution device 44 has distribution arms 50 which supply pre-clarified sewage to the filter containers 40. The filter containers 40 are designed as cylinders with vertical longitudinal axis, which receive filters with a circular cross-section. The filter containers 40 may, however, also have other cross-sectional shapes, such as a triangular shape or a polygonal shape or the shape of a circular segment. As a result, the space in the area of the rotary plate 38 can be used better for filtering. On one of the distribution arms 50, a throttle element 52 is shown in FIG. 3, via which the supply of sewage to the respective filter container can be throttled or shut off completely.

FIG. 4 schematically shows a side view of the second sewage tank 24. In one of the filter containers 40, layer-shaped filters 42 are drawn in.

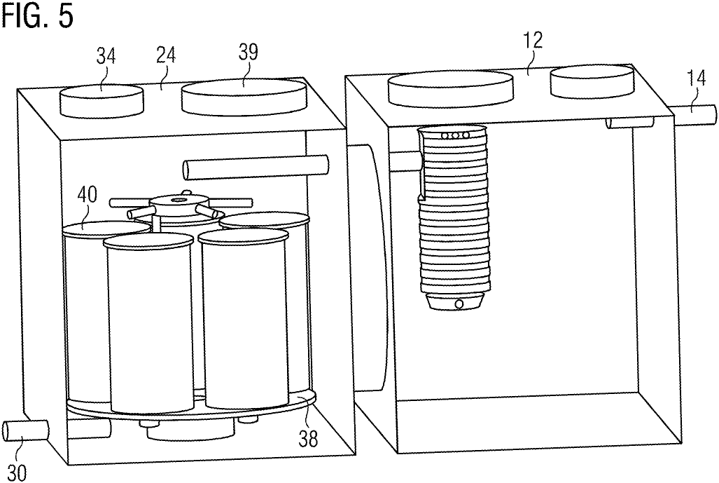

FIG. 5 shows a schematic CAD illustration in a perspective view. The various cylinder-shaped filter containers 40 are arranged on the rotary plate 38. Upon rotation of the rotary plate 38 about the axis 36, the filter containers 40 are rotated as well and can be aligned with the tank opening 39 in order to get access to the filter container 40 or the filters 42 contained therein.

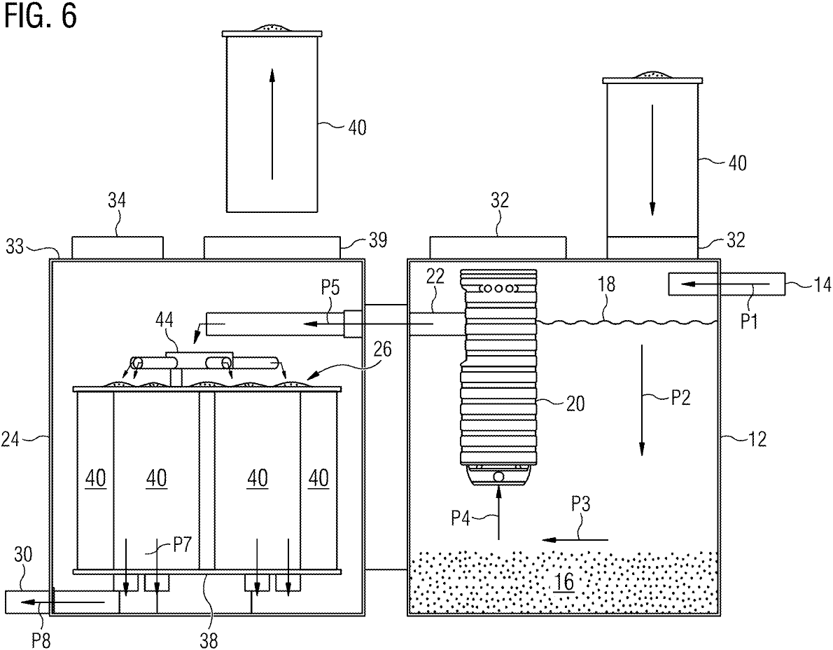

FIG. 6 shows the embodiment according to FIG. 2. The rotary plate 38 is rotated so far that a filter container 40 is opposite to the tank opening 39. This filter container 40 can then be removed via this opening and can be cleaned outside the second sewage tank 24. One version provides to place this filter container 40 onto the opening 32 in the first sewage tank 12 and to fix it thereat, for example by screwing. This makes it possible to rinse and clean this filter container 40 with high-pressure water from outside. The dirty water resulting therefrom reaches the first sewage tank 12. In this way, no dirty water is produced outside the small sewage treatment plant 10 when the filter containers 40 from the second sewage tank 24 are cleaned. The small sewage treatment plant 10 has a total volume of 2500 to 25000 liters. A filter container typically comprises a volume of 200 liters.

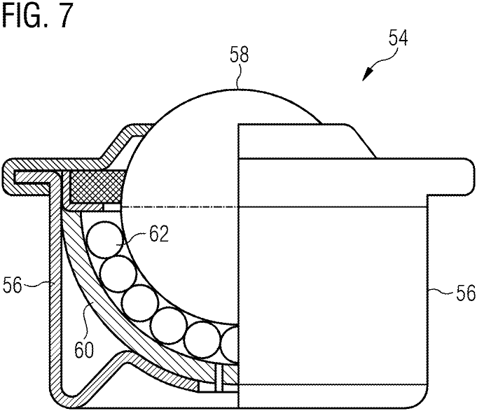

FIG. 7 schematically shows a ball transfer unit 54 which serves as a construction element for mounting and pivoting the rotary plate 38. The ball transfer unit 54 comprises a housing 56, a main ball 58, a bearing shell 60 and a plurality of small supporting balls 62, which are rotatable in all directions in a low-friction manner. These supporting balls 62 roll off on the bottom of the second sewage tank 24 in the bearing shell 60 upon rotation of the main ball 58. Several such ball transfer units 54 are fixed with their housings 56 to the rotary plate 38 and enable its rotation. As an alternative construction element with respect to the ball transfer unit, rolling elements, such as chair rolls or cylinder ball transfer units are usable. The rotation of the rotary plate 38 preferably takes place manually during cleaning. A motor-driven rotation is alternatively possible.

The embodiments shown may be modified in a variety of ways within the scope of the invention. For example, the rotary plate may comprise only a base plate on which the filter containers 40 stand. It is then advantageous to stably secure the filter containers 40 to this base plate. The base plate may also have recesses into which the filter containers 40 are inserted. A water collector may be arranged below the base plate and connected thereto, which collects the filtered sewage and leads it to the outlet 30.

Several filters 42 of a filter container 40 may also be combined to one filter group. When the filter container 40 is opposite to the tank opening 39, one or more filter groups may be removed and cleaned via this tank opening 39. In one embodiment, the filter containers 40 can be firmly connected to the rotary plate 38 and only filters 42 or filter groups are removed and cleaned via the tank opening 39. It is also advantageous when the first sewage tank 12 is rigidly connected to the second sewage tank 24, so that the entire small sewage treatment plant has improved stability.

What is claimed is:

1. A small sewage treatment plant, comprising
a first sewage tank with an inlet for sewage, in which a preliminary clarification takes place as a result of the sinking of solid particles to the bottom of the first sewage tank,
a second sewage tank which is connected to the first sewage tank via an overflow through which pre-clarified sewage is feedable to the second sewage tank,
a filtering device in the second sewage tank, which filtering device comprises several filters and to which the pre-clarified sewage is fed from above for further clarification,
and an outlet which is arranged below the filtering device and via which the filtered sewage is dischargeable,
characterized in that the filtering device comprises a rotary plate which is rotatable about a vertical axis of rotation and stores several filter containers, each filter container comprising several filters arranged one above the other, and that
in a lid of the second sewage tank a closeable tank opening is provided, via which at least one filter is removable when the associated filter container is opposite the tank opening after a corresponding rotation of the rotary plate.

2. The small sewage treatment plant according to claim 1, characterized in that the filter container is removable together with its filters.

3. The small sewage treatment plant according to claim 1, characterized in that a distribution device is present above the filtering device, which distribution device is connected to the overflow and via which pre-clarified sewage is feedable to at least one filter container.

4. The small sewage treatment plant according to claim 1, characterized in that each filter container is configured as a cylinder with a vertical longitudinal axis, which receives the filters with circular cross-section.

5. The small sewage treatment plant according to claim 1, in which several filters of a filter container are combined to one filter group, the filter group being removable via the tank opening.

6. The small sewage treatment plant according to claim 1, characterized in that the first sewage tank is formed as a closed tank.

7. The small sewage treatment plant according to claim 1, characterized in that the first sewage tank is rigidly connected to the second sewage tank.

8. The small sewage treatment plant according to claim 1, characterized in that the first sewage tank and the second sewage tank together comprise a holding volume of 10 to 40 m³.

9. The small sewage treatment plant according to claim 1, characterized in that the distribution device comprises at least one throttle elementwith which the supply of pre-clarified sewage to the filter container can be throttled.

10. The small sewage treatment plant according to claim 1, characterized in that the first sewage tank comprises in its lid a closeable opening into which the filter container can be inserted for cleaning.
